(19) United States
(12) Patent Application Publication
(10) Pub. No.: US 2010/0062032 A1
(43) Pub. Date: Mar. 11, 2010

(54) Doped Titanium Dioxide Coatings and Methods of Forming Doped Titanium Dioxide Coatings

(75) Inventor: PRAMOD K. SHARMA, Ann Arbor, MI (US)

Correspondence Address: O'BRIEN JONES, PLLC, 8200 Greensboro Drive, Suite 1020A, McLean, VA, 22102, US

(73) Assignee: GUARDIAN INDUSTRIES CORP., Auburn Hills, MI (US)

(21) Appl. No.: 12/207,167

(22) Filed: Sep. 9, 2008

(51) Int. Cl. A01N 25/34; B05D 3/02; A01P 1/00

(52) U.S. Cl. 424/409; 427/372.2; 427/383.1; 427/383.5

(57) ABSTRACT

Methods for forming doped titanium dioxide coatings are disclosed. Sol-gel compositions are prepared having at least one dopant, are formed on a substrate, and heated at a temperature sufficient to form a doped anatase titanium dioxide coating. Doped titanium dioxide coatings having at least one of improved antimicrobial properties, self-cleaning properties, hydrophilicity, and/or activation time are also disclosed. Substrates comprising such coatings are also disclosed.

### FIELD

The present invention relates generally to doped titanium dioxide coatings and methods of forming doped titanium dioxide coatings having improved photocatalytic activity.

### BACKGROUND

Titanium dioxide (TiO₂, also know as titania) has been widely studied because of its potential photocatalytic applications. Titanium dioxide only absorbs ultraviolet (UV) radiation. When UV light is illuminated on titanium dioxide, electron-hole pairs are generated. Electrons are generated in the conduction band and holes are generated in the valence band. The electron and hole pairs reduce and oxidize, respectively, adsorbates on the surface of the titanium dioxide, producing radical species such as OH⁻ and O₂⁻. Such radicals may decompose certain organic compounds. As a result, titanium dioxide coatings have found use in antimicrobial and self-cleaning coatings.

To activate the titanium dioxide to photogenerate these electron-hole pairs (i.e. photocatalytic activity), and thus to provide the titanium dioxide with antimicrobial and/or self-cleaning properties, titanium dioxide must be regularly dosed with photons of energy greater than or equal to about 3.0 eV (i.e., radiation having a wavelength less than about 413 nm). Depending on variables such as the structure, ingredients, and texture of titanium dioxide coatings, for example, dosing may takes several hours, such as, for example, 6 hours or more. Antimicrobial titanium dioxide coatings, therefore, must generally be exposed to UV radiation for at least 6 hours before achieving the full photocatalytic effect.

Efforts have been made to extend the energy absorption of titanium dioxide to visible light and to improve the photocatalytic activity of titanium dioxide. For example, foreign metallic elements such as silver can be added. This may, for example, aid electron-hole separation as the silver can serve as an electron trap, and can facilitate electron excitation by creating a local electric field.

Furthermore, titanium dioxide also has been shown to exhibit highly hydrophilic properties when exposed to UV radiation. Such hydrophilicity may be beneficial in certain embodiments, such as, for example, certain coating embodiments. Without wishing to be limited in theory, it is believed that the photoinduced hydrophilicity is a result of photocatalytic splitting of water by the mechanism of the photocatalytic activity of the titanium dioxide, i.e., by the photogenerated electron-hole pairs. When exposed to UV radiation, the water contact angle of titanium dioxide coatings approaches 0°, i.e., superhydrophilicity.

Current coating methods involving titanium dioxide often result in a disadvantageous loss of hydrophilicity and/or photocatalytic activity such as antimicrobial and/or self-cleaning properties of the titanium dioxide. This may be due to formation of different phases of the titanium dioxide during the coating process. For example, anatase titanium dioxide typically transforms to rutile phase titanium dioxide when heated at temperatures greater than 600° C., such as may be used during the coating process. The rutile phase has less desirable surface coating properties than the anatase phase, such as, for example, less desirable hydrophilicity and antimicrobial and/or self-cleaning properties.

There is thus a long-felt need in the industry for methods for forming a titanium dioxide coating having increased photocatalytic activity such as antimicrobial and/or self-cleaning properties and/or hydrophilicity, and/or a reduced dosing time. The invention described herein may, in some embodiments, solve some or all of these needs.

### SUMMARY

In accordance with various exemplary embodiments of the invention, methods for improving at least one of the hydrophilicity, activation time, and/or photocatalytic activity (and thus antimicrobial and/or self-cleaning properties) of titanium dioxide coatings have now been discovered.

In accordance with various exemplary embodiments of the invention are provided methods for forming doped anatase titanium dioxide coatings. At least one exemplary embodiment of the invention relates to methods for forming doped anatase titanium dioxide coatings comprising preparing a sol-gel composition comprising a dopant, coating a substrate with the sol-gel composition, and then heating the coating to form a doped anatase titanium dioxide coating.

Other exemplary embodiments of the invention relate to doped anatase titanium dioxide coatings having at least one improved property chosen from antimicrobial and/or self-cleaning properties, hydrophilicity, and/or activation time. Exemplary embodiments of the invention also include antimicrobial and/or self-cleaning coatings comprising doped anatase titanium coatings. Further embodiments include a substrate coated with a titanium dioxide coating according to various exemplary embodiments of the invention.

As used herein, “increased” or “improved photocatalytic activity” means any decrease in the activation time of, or any increase in the amount of organic material decomposed by, the titanium dioxide coating in a specified period of time when compared to coatings not according to various embodiments of the invention. Similarly, “increased” or “improved antimicrobial properties” or “increased” or “improved self-cleaning properties” likewise mean any increase in the amount of organic material decomposed by the titanium dioxide coating in a specified period of time when compared to coatings not according to various embodiments of the invention.

Throughout this disclosure, the terms “photocatatytic activity,” “antimicrobial properties,” and/or “self-cleaning properties” may be used interchangeably to convey that the antimicrobial and/or self-cleaning properties of the titanium dioxide coatings are a result of the photocatalytic activity of the coatings.

As used herein, “activation time” means the time required for a titanium dioxide coating illuminated with UV radiation to decompose a specified percentage of organic material over a period of time. Likewise, “decreased” or “reduced activation time” means any decrease in the amount of activation time required to decompose the specified percentage of organic material over a period of time when compared to coatings not according to various embodiments of the invention.

As used herein, “increased” or “improved hydrophilicity” means any decrease in the water contact angle when compared to coatings not according to various embodiments of the invention. The water contact angle is a measure of the angle between water and the surface of a material. A smaller water contact angle indicates a material that is more hydrophilic than a material with a higher water contact angle. Water droplets on more hydrophilic surfaces tend to spread out or flatten, whereas on less hydrophilic surfaces water tends to bead up or form droplets which are more spherical in shape, and the water contact angle of those surfaces is generally greater.

As used herein, the term “dopant” means a material other than titanium dioxide present in the coating in an amount such that the foreign material mixes completely with the matrix, i.e., the titanium dioxide, but that does not have a peak identifying it when analyzing the mixture by x-ray diffraction (XRD). However, a dopant may broaden or shift the peaks of titanium dioxide in an XRD pattern.

As used herein, the term “sol-gel composition” means a chemical solution comprising a titanium compound within the chemical solution that forms a polymerized titanium dioxide coating when the solvent is removed, such as by heating or any other means.

As used herein, the term “temperable” means a titanium dioxide coating that may be heated to a temperature sufficient to temper a substrate on which it is formed without forming rutile phase titanium dioxide.

As described herein, the invention relates to doped anatase titanium dioxide coatings and methods of forming doped anatase titanium dioxide coatings. In the following description, certain aspects and embodiments will become evident. It should be understood that the invention, in its broadest sense, could be practiced without having one or more features of these aspects and embodiments. It should be understood that these aspects and embodiments are merely exemplary and explanatory, and are not restrictive of the invention as claimed.

### BRIEF DESCRIPTION OF THE DRAWINGS

The following figures, which are described below and which are incorporated in and constitute a part of the specification, illustrate exemplary embodiments of the invention and are not to be considered limiting of the scope of the invention, for the invention may admit to other equally effective embodiments.

FIG. 1 is an absorbance spectrum of methylene blue on the titanium dioxide coating of the Comparative Example at various time intervals of UV illumination;

FIG. 2 is an absorbance spectrum of methylene blue on the silver oxide doped anatase titanium dioxide coating of Example 1 at various time intervals of UV illumination; and

FIG. 3 is an absorbance spectrum of methylene blue on the silver oxide doped anatase titanium dioxide coating of Example 2 at various time intervals of UV illumination.

### DESCRIPTION OF EXEMPLARY EMBODIMENTS

Reference will now be made to various exemplary embodiments of the invention, examples of which are illustrated in the accompanying figures. However, these various exemplary embodiments are not intended to limit the disclosure, but rather numerous specific details are set forth in order to provide a thorough understanding of the invention. However, it will be apparent to one skilled in the art that the invention may be practiced without some or all of these specific details, and the disclosure is intended to cover alternatives, modifications, and equivalents. For example, well-known features and/or process steps may not have been described in detail so as not to unnecessarily obscure the invention.

The present invention contemplates various exemplary methods of forming doped anatase titanium dioxide coatings in order to improve at least one of photocatalytic activity (and thus antimicrobial and/or self-cleaning properties), hydrophilicity, and/or activation time of the coating.

While not wishing to be bound by theory, it is believed that the band gap of the dopant alters the absorption of the titanium dioxide coating, which may, in turn, affect, either positively or negatively, the photocatalytic activity of the coating. An increase in absorption may lead to (1) improved photocatalytic activity such as antimicrobial and/or self-cleaning properties because the number of radicals may be directly related to the amount of surface area available, and/or (2) improved hydrophilicity because the number of radicals which are present and are available to be attracted to the water molecules is greater.

At least one exemplary embodiment of the invention contemplates methods of forming doped anatase titanium dioxide coatings comprising preparing a titanium dioxide sol-gel composition comprising at least one dopant, coating a substrate with the sol-gel composition, and heating the coating to form a doped anatase titanium dioxide coating.

In at least one exemplary embodiment, the titanium dioxide sol-gel composition comprises a titanium alkoxide or a titanium chloride. Examples of titanium alkoxides which may be used in sol-gel compositions according to the present invention include, but are not limited to, titanium n-butoxide, titanium tetra-iso-butoxide (TTIB), titanium isopropoxide, and titanium ethoxide. In at least one embodiment, the titanium dioxide sol-gel composition comprises titanium tetra-iso-butoxide.

In at least one embodiment, the sol-gel composition further comprises a surfactant, which may improve the coating process. Examples of surfactants which may be used in accordance with the present invention include, but are not limited to, non-ionic surfactants such as alkyl polysaccharides, alkylamine ethoxylates, castor oil ethoxylates, ceto-stearyl alcohol ethoxylates, decyl alcohol ethoxylates, and ethylene glycol esters.

In various exemplary embodiments, the at least one dopant is chosen from silver, silver oxide, tungsten, tungsten oxide, gold, and tin oxide. According to at least one exemplary embodiment, the at least one dopant is chosen from silver and silver oxide. In a further embodiment, the at least one dopant comprises colloidal silver.

In at least one embodiment of the present invention, a doped anatase titanium dioxide coating comprises a dopant in an amount comprising less than or equal to 5 wt %. In other embodiments, the doped anatase titanium dioxide coating comprises a dopant in an amount comprising less than or equal to 4 wt %, or less than or equal to 3 wt % relative to the total weight of the coating. In various embodiments, the doped anatase titanium dioxide coating comprises a dopant in an amount comprising 3 wt % to 5 wt % relative to the total weight of the coating.

In other embodiments, a dopant concentration greater than about 5 wt % can be used. One skilled in the art will appreciate that additional dopant may result in increased photocatalytic activity, but other effects may negatively impact the performance of the doped titanium dioxide coating. For example, if silver is used as a dopant, increased concentrations of silver may result in the reflection of light incident on the titanium dioxide coating, which may decrease the photocatalytic activity of the coating. Accordingly, the amount of dopant which can be used in any specific embodiment of the invention may easily be determined by one of skill in the art, in view of the desired properties of the coating.

In various exemplary embodiments, the doped anatase titanium dioxide coatings may be formed on a substrate. Accordingly, substrates coated with a doped titanium dioxide coating according to various exemplary embodiments of the invention are also contemplated herein. One of skill in the art will readily appreciate the types of substrates which may be coated with exemplary coatings as described herein.

In one exemplary embodiment, the substrate may comprise a glass substrate. In various exemplary embodiments, the glass substrate may be chosen from standard clear glass, such as float glass, or a low iron glass, such as ExtraClear™, UltraWhite™, or Solar glasses available from Guardian Industries.

In at least one embodiment, the substrate may be coated with the sol-gel composition by a method chosen from spin-coating the sol-gel composition on the substrate, spray-coating the sol-gel composition on the substrate, dip-coating the substrate with the sol-gel composition, and any other technique known to those of skill in the art.

In one exemplary embodiment, the sol-gel coated substrate may be heated at a temperature of 600° C. or greater, such as 625° C. or greater. In one exemplary embodiment, the sol-gel coated substrate may be heated for any length time sufficient to create a doped anatase titanium dioxide coating, such as, for example, about 3-4 minutes, such as, about 3½ minutes. One skilled in the art will appreciate that other temperatures and heating times may be used and should be chosen such that anatase titanium dioxide is formed. For example, titanium dioxide coatings may be heated at a temperature ranging from about 550° C. to about 650° C. Titanium dioxide coatings may be heated at lower temperatures as well, as long as anatase titanium dioxide is formed. One skilled in the art may choose the temperature and heating time based on, for example, the appropriate temperature and time for heating to form the doped anatase titanium dioxide coating, the properties of the desired doped titanium dioxide coating, such as thickness of the coating or thickness of the substrate, etc. For example, a thinner coating may require heating at a lower temperature or for a shorter time than a thicker coating. Similarly, a substrate that is thicker or has lower heat transfer may require a higher temperature or a longer time than a substrate that is thinner or has a high heat transfer. As used herein, the phrase “heated at” a certain temperature means that the oven or furnace is set at the specified temperature. Determination of the appropriate heating time and temperature is well within the ability of those skilled in the art, requiring no more than routine experimentation.

Temperable anatase titanium dioxide coatings may be formed according to at least one method of the present invention. For example, an anatase titanium dioxide coating formed on a glass substrate may be heated at a temperature sufficient to temper the glass substrate without forming the rutile phase of titanium dioxide, i.e., the titanium dioxide remains in the anatase phase when the glass substrate is tempered.

The present invention also contemplates, in at least one embodiment, a doped anatase titanium dioxide coating comprising at least one dopant. In at least one embodiment, the at least one dopant is chosen from silver, silver oxide, tungsten, tungsten oxide, gold, and tin oxide. According to one embodiment, the at least one dopant comprises colloidal silver. Such coatings may, in certain embodiments, have properties chosen from increased photocatalytic activity (and thus antimicrobial and/or self-cleaning properties), hydrophilicity, and/or decreased activation time.

Various exemplary methods in accordance with the invention may improve at least one of hydrophilicity and photocatalytic activity such as antimicrobial and/or self-cleaning properties of the coatings.

In at least one embodiment, the doped titanium dioxide coating may be used as an antimicrobial and/or self-cleaning coating. Accordingly, a substrate having improved antimicrobial and/or self-cleaning properties, coated with a doped titanium dioxide coating according to various embodiments of the invention, can be provided.

The present invention also contemplates, in at least one embodiment, a doped titanium dioxide coating having improved hydrophilicity, such as, for example, when formed on a substrate.

The present invention is further illustrated by the following non-limiting examples, which are provided to further aid those of skill in the art in the appreciation of the invention.

Unless otherwise indicated, all numbers herein, such as those expressing weight percents of ingredients and values for certain physical properties, used in the specification and claims are to be understood as being modified in all instances by the term “about,” whether so stated or not. It should also be understood that the precise numerical values used in the specification and claims form additional embodiments of the invention. Efforts have been made to ensure the accuracy of the numerical values disclosed in the Examples. Any measured numerical value, however, can inherently contain certain errors resulting from the standard deviation found in its respective measuring technique.

As used herein, a “wt %” or “weight percent” or “percent by weight” of a component, unless specifically stated to the contrary, is based on the total weight of the composition or article in which the component is included. As used herein, all percentages are by weight unless indicated otherwise.

It is noted that, as used in this specification and the appended claims, the singular forms “a,” “an,” and “the,” include plural referents unless expressly and unequivocally limited to one referent, and vice versa. Thus, by way of example only, reference to “a substrate” can refer to one or more substrates, and reference to “a doped titanium dioxide coating” can refer to one or more doped titanium dioxide coatings. As used herein, the term “include” and its grammatical variants are intended to be non-limiting, such that recitation of items in a list is not to the exclusion of other like items that can be substituted or added to the listed items.

It will be apparent to those skilled in the art that various modifications and variation can be made to the present disclosure without departing from the scope its teachings. Other embodiments of the disclosure will be apparent to those skilled in the art from consideration of the specification and practice of the teachings disclosed herein. It is intended that the embodiments described in the specification be considered as exemplary only.

### EXAMPLES

### Comparative Example

A titanium dioxide sol was prepared by mixing 6 g of titanium tetra-iso-butoxide (TTIB) in a solution containing 25 g of ethanol and 2 g of nitric acid. The mixture was stirred for 1 h. The pure titanium dioxide coating was fabricated by spin coating a glass substrate at 700 rpm for 30 s. The coating was heat treated in a furnace at 625° C. for 3½ min. The formed titanium dioxide coating was pure anatase phase titanium dioxide. The anatase titanium dioxide coating had a water contact angle of 8°. After 20 hours of exposure to UV light, the water contact angle decreased to 3.8°, a reduction of about 13% in the water contact angle.

The photocatalytic activity (antimicrobial activity) of the examples disclosed herein was tested using a methylene blue test that measured the degradation of methylene blue on the anatase titanium dioxide coatings. To perform the methylene blue test, 0.5 g of methylene blue powder were dissolved in 50 ml of ethanol and placed in a bottle covered with black paper to avoid UV degradation of the methylene blue by light sources in the room. The solution was stirred for 1 h. The methylene blue solution was spin coated on the surface of the anatase titanium dioxide coating at 1000 rpm for 30 sec. The methylene blue concentration was analyzed by an UV-Vis spectrometer in the wavelength range from 300 nm to 780 nm. Methylene blue shows an absorbance peak at 610-625 nm. Any reduction in that peak after exposure to UV light indicated degradation of methylene blue.

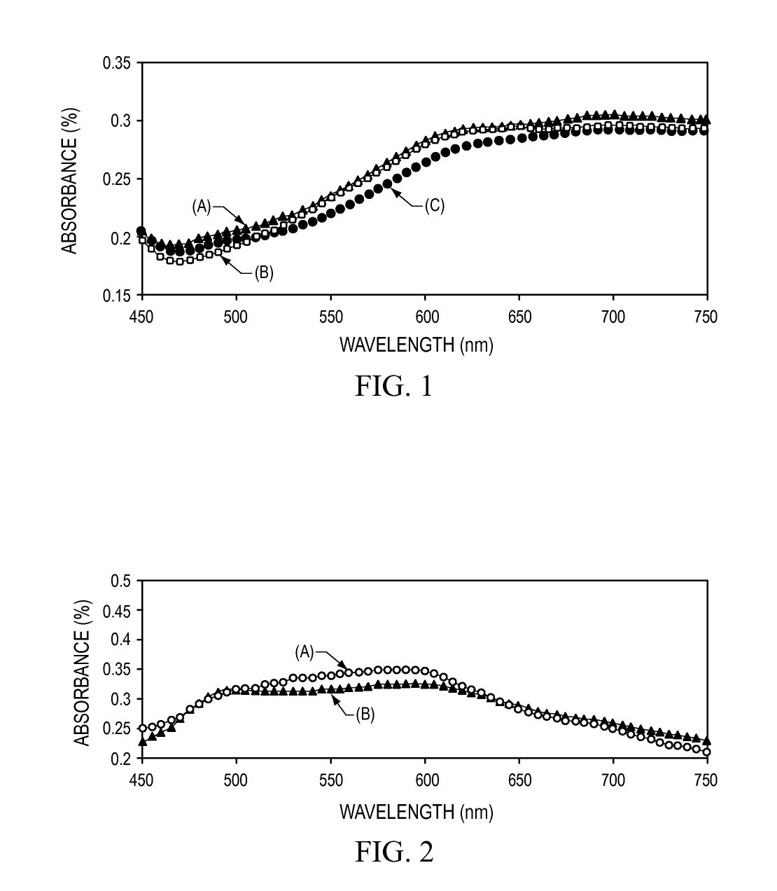

FIG. 1 shows the absorbance spectra of the methylene blue test of pure anatase titanium dioxide coating of the Comparative Example. In each of the absorbance spectrums shown in FIGS. 1-3, the spectrums are labeled after UV illumination for (A) 0 h, (B) 6 h, and (C) 20 h. After 20 hours of UV exposure, the methylene blue in the Comparative Example degraded by about 3%.

### Example 1

The titanium dioxide sol used to prepare the titanium dioxide coating of Example 1 was prepared similar to the titanium dioxide sol of the Comparative Example.

A silver colloid solution was prepared by heating 250 g of water to a boil. 50 mg of silver nitrate were added to the water. A separate solution of 1 g of sodium citrate in 100 g of water was prepared. Once the water with silver nitrate came to a boil, 10 g of the sodium citrate solution were added to it. The solution was stirred for 30 min and then allowed to cool to room temperature. The resulting colloid was greenish yellow, indicating good crystallinity of the silver product.

5 g of the titanium dioxide sol were mixed with 1 g of the silver colloid solution and stirred for 10 minutes. A coating was then formed on a substrate by spin coating at 700 rpm for 30 s. The coated substrate was then heat treated in a furnace at 625° C. for 3½ min.

The water contact angle of the silver oxide doped anatase titanium dioxide coating of Example 1 was 17°. After exposing the doped anatase titanium dioxide coating to UV light for 20 hours, the water contact angle decreased to 6.2°, a reduction of 64%.

FIG. 2 is an absorbance spectrum of the doped anatase titanium dioxide coating of Example 1 at various time intervals of UV illumination. As seen in FIG. 2, the methylene blue on the doped anatase titanium dioxide coating degraded about 6% after 20 hours of exposure to UV light.

### Example 2

The titanium dioxide sol used to prepare the titanium dioxide coating of Example 1 was prepared similar to the titanium dioxide sol of the Comparative Example.

A silver solution was prepared by dissolving 0.033 g of silver nitrate in 3 ml of ethanol and 2 ml of nitric acid. The silver salt solution was mixed for 3 h as the silver nitrate slowly dissolved in the ethanol. 1 g of the silver nitrate solution was then added to 5 g of the titanium dioxide sol as in Example 1. The resulting solution was mixed for 2 h. The silver oxide doped anatase titanium dioxide coating of Example 2 was formed by spin coating at 700 rpm for 30 s and then heat treating the coating in a furnace at 625° C. for 3½ min.

The water contact angle of the silver oxide doped anatase titanium dioxide coating of Example 2 was 9.6°. After exposing the doped anatase titanium dioxide coating to UV light for 20 hours, the water contact angle decreased to about 3°, a reduction of about 70%.

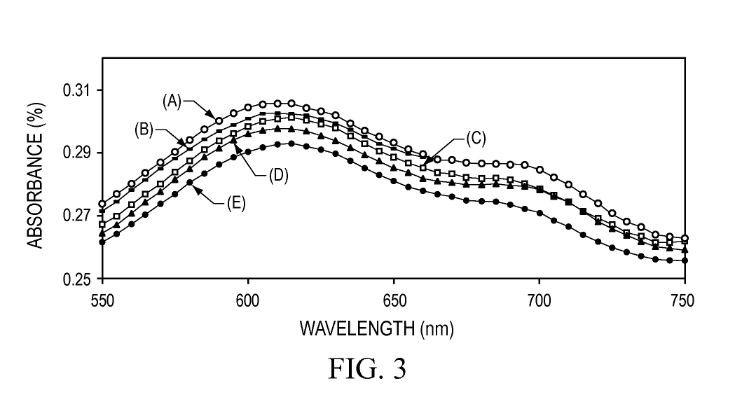

FIG. 3 is an absorbance spectrum of the doped anatase titanium dioxide coating of Example 2 at various time intervals of UV illumination. As seen in FIG. 3, the methylene blue on the doped anatase titanium dioxide coating degraded about 4% after 20 hours of exposure to UV light.

As evidenced by Examples 1 and 2, silver oxide doped anatase titanium dioxide coatings increase the photocatalytic activity (antimicrobial activity) of anatase titanium dioxide. In addition, silver oxide doped anatase titanium dioxide coatings provide a greater reduction in water contact angle after exposure to UV light as opposed to pure anatase titanium dioxide coatings.

What is claimed is:

1. A method of forming a doped anatase titanium dioxide coating on a substrate, comprising:
preparing a titanium dioxide sol-gel composition comprising at least one dopant;
coating the substrate with the sol-gel composition; and
heating the coated substrate to form a doped anatase titanium dioxide coating.

2. The method of claim 1, wherein said at least one dopant is chosen from silver, silver oxide, tungsten, tungsten oxide, gold, and tin oxide.

3. The method of claim 2, wherein said at least one dopant is chosen from silver and silver oxide.

4. The method of claim 3, wherein said at least one dopant comprises colloidal silver.

5. The method of claim 3, wherein the at least one dopant is a silver nitrate solution.

6. The method of claim 1, wherein said substrate comprises a glass substrate.

7. The method of claim 6, wherein said glass substrate is chosen from clear and low-iron glass substrates.

8. The method of claim 1, wherein the coated substrate is heated at a temperature greater than about 600° C.

9. A method of improving at least one of antimicrobial properties, self-cleaning properties, hydrophilicity, and activation time of a titanium dioxide coating, comprising:
preparing a titanium dioxide sol-gel composition comprising at least one dopant;
coating a substrate with the sol-gel composition; and
heating the coated substrate to form a doped anatase titanium dioxide coating.

10. The method of claim 9, wherein said at least one dopant is chosen from silver, silver oxide, tungsten, tungsten oxide, gold, and tin oxide.

11. The method of claim 10, wherein said at least one dopant is chosen from silver and silver oxide.

12. The method of claim 11, wherein said at least one dopant comprises colloidal silver.

13. The method of claim 11, wherein the at least one dopant is a silver nitrate solution.

14. The method of claim 9, wherein said substrate is chosen from clear and low-iron glass.

15. The method of claim 9, wherein the coated substrate is heated at a temperature greater than about 600° C.

16. An antimicrobial coating, comprising:
a substrate;
a doped anatase titanium dioxide coating on a surface of said substrate.

17. The antimicrobial coating of claim 16, wherein the doped anatase titanium dioxide coating comprises up to about 5 wt % of a dopant.

18. The antimicrobial coating of claim 16, wherein the doped anatase titanium dioxide coating comprises at least one dopant chosen from silver, silver oxide, tungsten, tungsten oxide, gold, and tin oxide.

19. The antimicrobial coating of claim 18, wherein the at least one dopant is chosen from silver and silver oxide.

20. The antimicrobial coating of claim 19, wherein the at least one dopant comprises silver oxide.

21. The antimicrobial coating of claim 16, wherein said substrate comprises a glass substrate.

22. The antimicrobial coating of claim 21, wherein said glass substrate is chosen from clear and low-iron glass substrates.

23. A doped titanium dioxide coating having at least one of improved antimicrobial properties, improved self-cleaning properties, and improved hydrophilicity, wherein said doped titanium dioxide coating is made by:
preparing a titanium dioxide sol-gel composition comprising at least one dopant;
coating a substrate with the sol-gel composition; and
heating the coated substrate to form a doped anatase titanium dioxide coating.
